(19) United States
(12) Patent Application Publication
(10) Pub. No.: US 2006/0153079 A1
(43) Pub. Date: Jul. 13, 2006

(54) Apparatus and method for setting up QoS in a mobile communication system

(75) Inventors: Seung-Il Yoon, Seongnam-si (KR); Nae-Hyun Lim, Yongin-si (KR); Jin-Soo Jeong, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/316,916

(22) Filed: Dec. 27, 2005

(30) Foreign Application Priority Data
Dec. 24, 2004 (KR) 2004-112411

(51) Int. Cl. H04J 1/16

(52) U.S. Cl. 370/235

(57) ABSTRACT

Provided is an apparatus and method for setting up aquality-of-service (QoS) in a mobile communication system. A mobile terminal (MT) generates a resource reservation message including requested QoS information and packet filtering information for a predetermined service. A packet data service node (PDSN) stores the QoS information and the packet filtering information. Upon receiving packet data corresponding to the stored QoS information from the external network, the PDSN sends a request for a new QoS setup to the AN. An access network (AN) determines a granted QoS to be applied to a wireless session and sends a request for new QoS setup to the MT. If the MT grants the new QoS setup, the MT sends a response to the new QoS setup request from the MT to the PDSN via the AN.

### CROSS-REFERENCE TO RELATED PATENT APPLICATIONS

This application claims the benefit under 35 U.S.C. § 119(a) of Korean Patent Application No. 2004-112411, filed Dec. 24, 2004, in the Korean Intellectual Property Office, the entire disclosure of which is hereby incorporated by reference.

### BACKGROUND OF THE INVENTION

1. Field of the Invention

The present invention relates to an apparatus and method for setting up Quality-of-Service (QoS) in a mobile communication system. More particularly, the present invention relates to an apparatus and method for providing a data service with QoS in a mobile communication system.

2. Description of the Related Art

Mobile communication systems have evolved from the IS-95 standard that mainly supports the transmission and reception of voice signals, into IS-2000 and IS-856 standards that can support the transmission of high-rate data as well as voice signals. In particular, the CDMA2000 1x and 1xEv-DO systems support packet-based data transmission.

A packet transmission scheme based on the CDMA2000 1x system and the 1xEV-DO system transmits packets on a “best effort” basis. Despite this, the packet transmission scheme handles real-time services that are susceptible to transmission delay, such as a video telephony services and a Voice over Internet Protocol (VoIP) services. However, the packet transmission scheme cannot guarantee data transmission for the services that are susceptible to transmission delay. Moreover, even data services that are not susceptible to transmission delay, such as file transfer protocol (FTP) upload services, cannot guarantee stable data transmission, because it requires different QoSs according to network conditions. Therefore, for the packet-based data transmission, there has been introduced a QoS Support scheme for guaranteeing a service according to a bandwidth, a data rate, and/or communication quality that was previously required by a user.

The QoS Support scheme, when it is taken into account in terms of a CDMA2000 network, can be divided into an IP QoS Support scheme defined in a network layer and a QoS Support scheme defined in an access network, a lower layer, for supporting the IP QoS Support scheme. The ongoing standardization of the IP QoS Support scheme has been largely led by Internet Engineering Task Force (IETF), an international standardization organization. The IP QoS Support scheme typically includes an Int-Serv scheme and a Diff-Serv scheme.

The Int-Serv scheme transmits data after setting up a necessary resource through a pre-reservation process before data transmission at each node intending to transmit data, and uses a Resource reSerVation Protocol (RSVP) as a signaling protocol for resource reservation.

The Diff-Serv scheme designates relative priorities for packets in a data header at each node intending to transmit data, and differential-processes the packets based on information acquired through the header.

The IP QoS Support scheme, available in an IP node, is applicable to a mobile terminal (MT), a packet data service node (PDSN), and several routers constituting an IP core network, in the CDMA2000 network.

QoS setup in the mobile communication system is performed when an application program or service requiring QoS setup is performed in a MT. As such, user traffic must be instantaneously transmitted either bidirectionally or unidirectionally. A main service with a basic QoS is generated if a MT sets up a basic call to a base station system (BSS). In a basic QoS of the main service, traffic is processed between application programs without a priority difference on a First-In First-Out (FIFO) basis. However, compared with others, application services that have less packets but are susceptible to delay, such as VoIP services, should be assigned a higher priority so that it can be transmitted earlier than others. To this end, if a corresponding service is executed, an auxiliary service is generated having a different QoS setup than the main service. An MT transmits a message, requesting a new QoS for an auxiliary service, to a BSS through a signaling message for a wireless session. The BSS, if it accepts the new QoS request, generates an auxiliary service through R-P setup (Radio Access Network (RAN)-Packet Data Service Node (PDSN) setup) and grants QoS decision for the wireless session. In this case, the BSS determines a granted QoS to be applied in the wireless session and network session by performing a QoS authentication process according to Call Admission Control (CAC) and a QoS profile for each individual user using the QoS requested by the MT. Thereafter, if a forward packet (or downlink packet) for a corresponding service is received after the MT transmits forward packet filtering information of a new service to the PDSN, the BSS transmits the received packet to the MT according to wireless-session QoS scheduling based on the set QoS. However, the foregoing method is inappropriate in, for example, a Push service in which a server rather than the MT intends to deliver a forward packet based on the new QoS. Therefore, in order to support the Push service, there is a need for a scheme in which a network initiates a request for the QoS setup.

In other words, because the Push service unilaterally transmits the service from the server to the MT at a predetermined time or if a predetermined condition is satisfied, instead of immediately transmitting the result requested by the MT, the network requires a process of requesting a new QoS setup when necessary.

Accordingly, there is a need for an improved apparatus and method for providing a data service with QoS in a mobile communication system utilizing a Push service so that a network can request a new QoS setup when necessary.

### SUMMARY OF THE INVENTION

An aspect of the exemplary embodiments of the present invention is to address at least the above problems and/or disadvantages and to provide at least the advantages described below. Accordingly, an aspect of the exemplary embodiments of the present invention is to provide a QoS setup apparatus and method in which a network requests new QoS setup when necessary.

It is another object of the exemplary embodiments of the present invention to provide an apparatus and method in which a PDSN performs network-initiated QoS setup upon receiving a QoS request and packet filtering information for a particular service from a server of the network.

It is further another object of the exemplary embodiments of the present invention to provide a QoS setup apparatus and method in which an MT performs an actual QoS setup process for a particular service upon receiving a packet for the corresponding service from a server of a network, such as a call session control function (CSCF) or management server, after transmitting a QoS request and packet filtering information for the corresponding service to a PDSN on a reservation basis.

According to one aspect of the exemplary embodiments of the present invention, there is provided a method for setting up a quality-of-service (QoS) in a mobile communication system including a mobile terminal (MT), an access network (AN) for performing packet communication with the MT, a packet control function (PCF) for controlling an exchange of packet data between the AN and the MT, and a packet data service node (PDSN) for exchanging packet data with the PCF and for connecting with an external network. The method comprises the steps of: generating, by the MT, a resource reservation message including requested QoS information and packet filtering information for a predetermined service; storing, by the PDSN, the QoS information and the packet filtering information; sending a request for new QoS setup from the PDSN to the AN, upon receiving packet data corresponding to the stored QoS information from the external network; determining, by the AN, a granted QoS to be applied to a wireless session; sending, by the AN, a request for new QoS setup to the MT; and sending, if the MT grants the new QoS setup, a response to the new QoS setup request from the MT to the PDSN via the AN.

According to another aspect of the exemplary embodiments of the present invention, there is provided a method for setting up a quality-of-service (QoS) in a mobile communication system including a mobile terminal (MT), an access network (AN) for performing packet communication with the MT, a packet control function (PCF) for controlling an exchange of packet data between the AN and the MT, and a packet data service node (PDSN) for exchanging packet data with the PCF and for connecting with an external network. The method comprises the steps of: receiving, by the PDSN, a new QoS setup request message including requested QoS information and packet filtering information from the external network; delivering, by the PDSN, the received new QoS setup request message to the AN; performing, by the AN, authentication using the requested QoS; determining, by the AN, a granted QoS to be applied to a wireless session; transmitting, by the AN, a new QoS setup request message to the MT; transmitting, if the MT grants new QoS setup, a new QoS setup response message from the MT to the PDSN; storing, by the PDSN, the QoS information and the packet filtering information; and transmitting, by the PDSN, the new QoS setup response message to the external network.

According to further another aspect of the exemplary embodiments of the present invention, there is provided a method for setting up a quality-of-service (QoS) in a packet data service node (PDSN) for a mobile communication system including a mobile terminal (MT), an access network (AN) for performing packet communication with the MT, a packet control function (PCF) for controlling an exchange of packet data between the AN and the MT, and the PDSN for exchanging packet data with the PCF and for connecting with an external network. The method comprises the steps of: receiving from the MT a resource reservation protocol (RSVP) message including requested QoS information and packet filtering information for a predetermined service; storing the received QoS information and packet filtering information; sending a request for new QoS setup to the AN, upon receiving packet data corresponding to the stored QoS information from the external network; and receiving a response to the new QoS setup request via the AN if the AN determines a granted QoS to be applied to a wireless session and sends a request for a new QoS setup to the MT, and the MT grants the new QoS setup.

According to yet another aspect of the exemplary embodiments of the present invention, there is provided a method for setting up a quality-of-service (QoS) in a packet data service node (PDSN) for a mobile communication system including a mobile terminal (MT), an access network (AN) for performing packet communication with the MT, a packet control function (PCF) for controlling an exchange of packet data between the AN and the MT, and the PDSN for exchanging packet data with the PCF and for connecting with an external network. The method comprises the steps of: receiving a new QoS setup request message including requested QoS information and packet filtering information from the external network, and delivering the received new QoS setup request message to the AN; receiving a new QoS setup response message from the MT, if the AN performs authentication in response to the QoS setup request, determines a granted QoS to be applied to a wireless intervalsession and transmits a new QoS setup request message to the MT, and the MT grants the new QoS setup; storing the QoS information and the packet filtering information; and transmitting the new QoS setup response message to the external network.

According to yet another aspect of the exemplary embodiments of the present invention, there is provided a method for setting up a quality-of-service (QoS) in a mobile terminal (MT) for a mobile communication system including the MT, an access network (AN) for performing packet communication with the MT, a packet control function (PCF) for controlling an exchange of packet data between the AN and the MT, and a packet data service node (PDSN) for exchanging packet data with the PCF and for connecting with an external network. The method comprises the steps of: generating a resource reservation protocol (RSVP) message including requested QoS information and packet filtering information for a predetermined service; transmitting the generated RSVP message to the PDSN; sending a request for a new QoS setup to the AN and receiving a new QoS setup request from the AN that determines a granted QoS to be applied to a wireless session, if the PDSN stores the QoS information and the packet filtering information and receives packet data corresponding to the stored QoS information from the external network; and sending a response to the new QoS setup request to the PDSN via the AN if the MT grants the new QoS setup.

According to yet another aspect of the exemplary embodiments of the present invention, there is provided a method for setting up a quality-of-service (QoS) in a mobile communication system including a mobile terminal (MT), an access network (AN) for performing packet communication with the MT, a packet control function (PCF) for controlling an exchange of packet data between the AN and the MT, and a packet data service node (PDSN) for exchanging packet data with the PCF and for connecting with an external network. The method comprises the steps of: delivering, by the PDSN, a new QoS setup request message including requested QoS information and packet filtering information received from the external network to the AN; receiving, from the AN, a new QoS setup request message that performs authentication in response to the QoS setup request and determines a granted QoS to be applied to a wireless session; transmitting, if the MT grants the new QoS setup, a new QoS setup response message from the MT to the PDSN; and storing, by the PDSN, the QoS information and the packet filtering information; and transmitting, by the PDSN, the new QoS setup response message to the external network.

According to still another aspect of the exemplary embodiments of the present invention, there is provided an apparatus for setting up a quality-of-service (QoS) in a mobile terminal (MT) for a mobile communication system including the MT, an access network (AN) for performing packet communication with the MT, a packet control function (PCF) for controlling an exchange of packet data between the AN and the MT, and a packet data service node (PDSN) for exchanging packet data with the PCF and for connecting with an external network. The apparatus comprises a QoS manager for transmitting a QoS registration request message including a requested QoS in order to deliver QoS information requested by a client to the PDSN; and a resource reservation protocol (RSVP) handler for delivering packet filtering information to the PDSN via an Internet protocol (IP) layer.

According to still another aspect of the exemplary embodiments of the present invention, there is provided an apparatus for setting up a quality-of-service (QoS) in a packet data service node (PDSN) for a mobile communication system including a mobile terminal (MT), an access network (AN) for performing packet communication with the MT, a packet control function (PCF) for controlling an exchange of packet data between the AN and the MT, and the PDSN for exchanging packet data with the PCF and for connecting with an external network. The apparatus comprises a traffic filtering storage for storing packet filtering information and requested QoS information received from the MT; a packet handler for classifying a packet received from the external network; a session handler for performing a QoS setup if the packet received from the external network coincides with the packet filtering information stored in the traffic filtering storage; and a signaling handler for transmitting the packet to the MT.

Other objects, advantages, and salient features of the exemplary embodiments of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a block diagram illustrating a configuration of a mobile communication system according to an exemplary embodiment of the present invention;

FIG. 2 is a block diagram illustrating a structure of an MT in a mobile communication system according to an exemplary embodiment of the present invention;

FIG. 3 is a block diagram illustrating a structure of a PDSN in a mobile communication system according to an exemplary embodiment of the present invention;

FIG. 4 is a signaling diagram illustrating a QoS setup method in a mobile communication system according to an exemplary embodiment of the present invention; and

FIG. 5 is a signaling diagram illustrating a QoS setup method in a mobile communication system according to another exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Exemplary embodiments of the present invention will now be described in detail with reference to the annexed drawings.

The present invention provides an apparatus and method for performing a QoS setup initiated by a network in a mobile communication system that supports a Push service or a VoIP service using a wireless network.

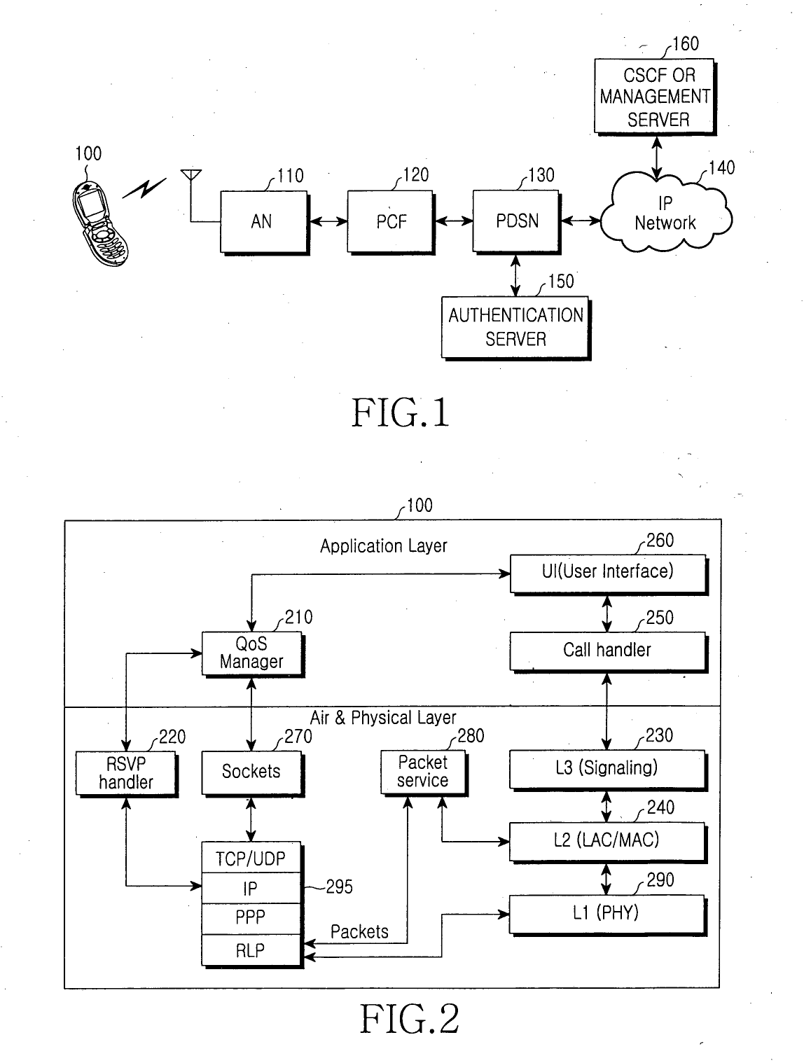

FIG. 1 is a block diagram illustrating a configuration of a mobile communication system supporting QoS, such as a CDMA2000 1x system or an EV-DO system, according to an exemplary embodiment of the present invention.

The mobile communication system includes a mobile terminal (MT) 100 that can support QoS and make a wireless access based on CDMA2000 1x standard or EV-DO standard, and a radio access network (RAN) (or an access network (AN)) 110 that exchanges packets with the MT 100 over a wireless channel. The RAN is called an “access network (AN)” in the EV-DO system, but is called a “base station system (BSS)” in the CDMA2000 1x system. Herein, the AN will represent either the RAN or the BSS. In addition, the mobile communication system includes a packet control function (PCF) 120 that connects the AN 110 to a packet data service node (PDSN) 130 and controls the PDSN 130 to provide packet data service and voice service, and the PDSN 130 that connects the PCF 120 to an IP network 140 and provides packet data service and voice service to the MT 100. The PDSN 130 is coupled to an authentication server 150 and is used for authentication. The IP network 140 is connected to a call session control function (CSCF) or management server 160.

The CSCF or management server 160 is a correspondent node (CN) with which the MT 100 desires to communicate, and this can be replaced with a server in the Internet.

In an exemplary embodiment of the present invention for setting up a QoS in the mobile communication system, the MT 100 transmits a QoS request and packet filtering information for a particular service to the AN/PDSN 110/130 on a reservation basis. Thereafter, upon receiving a packet for the particular service from the network, the MT 100, the AN/PCF 110/120 and the PDSN 130 perform an actual QoS setup process for the corresponding service.

In another exemplary embodiment of the present invention for setting up a QoS in the mobile communication system, upon receiving from the server a new QoS Setup Request message including a requested QoS and packet filtering information for a new service, the MT 100, the AN/PCF 110/120, and the PDSN 130 perform an actual QoS setup process for the corresponding service.

With reference to FIG. 2, a description will now be made of an operation of the MT according to an exemplary embodiment of the present invention.

The MT 100, as illustrated in FIG. 2, is roughly divided into an application layer and an air-and-physical layer.

A call handler 250 in the application layer handles a call processing request transmitted from a subscriber of the MT 100 via a user interface (UI) 260.

The MT 100 according to an exemplary embodiment of the present invention should have a previously registered QoS in the AN/PDSN 110/130. Referring to FIG. 2, a client that provides a Push service to the MT 100, transmits QoS and packet filtering information to a QoS manager 210 that is provided by the MT 100 for reservation of the service requested by the client.

The QoS manager 210, located in the application layer of the MT 100, provides an interface for Layer 3 (L3) (signaling) 230 and a Medium Access Control (MAC) of Layer 2 (L2) 240. Further provided is a physical (PHY) Layer 1 (L1) 290. If the QoS manager 210 sends a QoS registration request to L3 230 via UI 260 and call handler 250 in order to deliver the QoS requested by the client to AN 110, the L3 230 delivers a QoS Registration Request message to AN 110. Upon receiving the QoS Registration Request message, the AN 110 compares it with a QoS user profile previously acquired from an authentication server 150 in a user authentication process to determine whether QoS support is available. In this case, the AN 110 does not determine the QoS that it will actually be supported in the wireless session.

If AN 110 succeeds in registration of the QoS requested by L3 230 of the MT 100, it provides information indicating the success in the QoS registration to L3 230 of MT 100. Then L3 230 of MT 100 provides information indicating the success in the QoS registration to QoS manager 210 via call handler 250 and UI 260.

Thereafter, QoS manager 210 requests an RSVP handler 220 of MT 100 to transmit an RSVP message including packet filtering information to PDSN 130. The packet filtering information comprises port information, a destination address and an IP address. In a traffic state, MT 100 transmits a general radio link protocol (RLP) packet in the MAC of L2 240. However, in an idle state, MT 100 delivers a Short Data Burst (SDB) (for CDMA2000 1x) or a Data Over Signaling (for EV-DO) message including an RSVP message, to AN 110 through L3 230.

Generally, in data services, sockets 270 are a program interface. If MT 100 desired to receive data service from the application layer over UI 260, it can achieve it by simply calling a function provided by sockets 270. Then the MT 100 provides a packet service setup and a data transmission/reception by delivering the corresponding function to a handler 295 such as TCP/UDP. A packet service 280 controls several application programs for receiving packet services, and manages a main service or an auxiliary service.

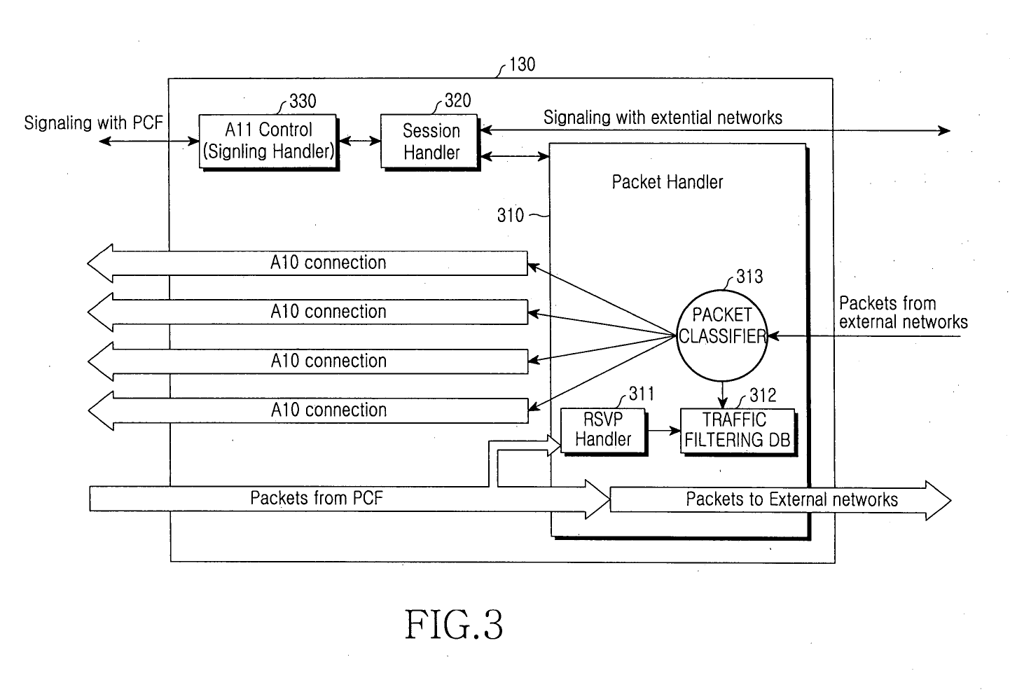

The AN 110 transmits an RSVP message including the packet filtering information to the PDSN 130, regarding it as general packet data. It will now be described with reference to FIG. 3 how the PDSN 130 processes the received RSVP message including the packet filtering information.

FIG. 3 is a block diagram illustrating a structure of a PDSN in a mobile communication system according to an exemplary embodiment of the present invention.

A Packet handler 310 of the PDSN 130 receives a QoS Registration message delivered via PCF 120. The QoS Registration message includes packet filtering information. Upon receiving the QoS Registration message, RSVP handler 311 stores the packet filtering information included in the QoS Registration message in a traffic filtering database (DB) 312. Thereafter, upon receiving a packet from an external network, a packet classifier 313 reports the receipt of the packet to a session handler 320 if the received packet service coincides with the stored packet filtering information. The session handler 320 then performs a QoS setup. After successful completion of the QoS setup, the session handler 320 delivers packet data to the MT 100 via an A11 signaling handler 330.

In the conventional client-server model, an MT sends a request when necessary, and a server transmits the requested service in response to the request. That is, for a new service, the MT requests a new QoS setup that is needed for the service. However, in a Push service, the server transmits the service to the MT at a predetermined time, if a predetermined condition is satisfied, or unilaterally, rather than immediately transmitting the service at the request of the MT.

Therefore, when the previously set QoS can be used as is and a forward packet to be delivered to the MT using a different QoS is generated in the network, the network requires a process for sending a new QoS setup request to the MT after or before performing a QoS setup in a wireless session and an R-P session. In the conventional scheme, the MT sends a new QoS setup request (MT-initiated QoS setup) in a method of using a signaling message in a wireless session or an RSVP message in a transport layer. On the contrary, however, a Push service requires a network-initiated new QoS setup because it sends a new QoS setup request to the MT over a wireless session.

Broadcast services can also employ the network-initiated new QoS setup. For example, the network-initiated new QoS setup can be applied to a static broadcast service for setting up a broadcast service in the network and wireless sessions regardless of the presence or absence of MTs.

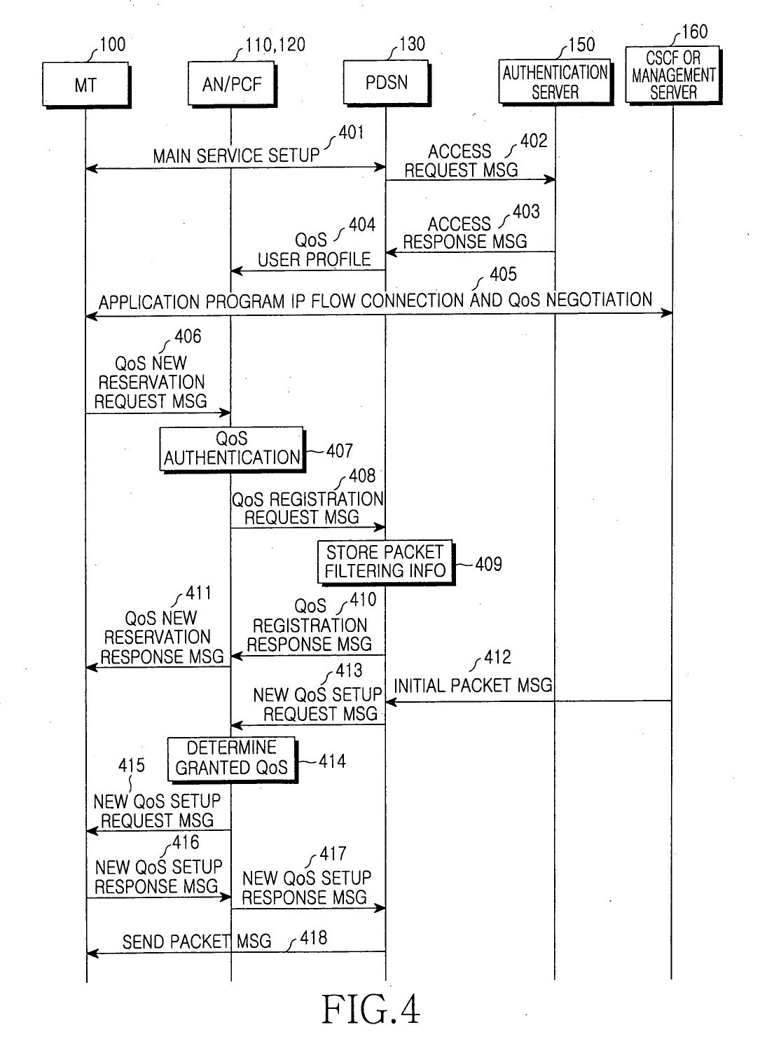

With reference to FIG. 4, a description will now be made of a QoS setup method in a mobile communication system according to an exemplary embodiment of the present invention.

In the conventional technology, if an MT sends a new QoS setup request to a network, the network determines a granted QoS to be applied during an actual wireless-session transmission through a QoS authentication process and call admission control (CAC), and also performs an R-P setup.

On the contrary, however, in an exemplary embodiment of the present invention, an MT has previously sent to a network a requested QoS and packet filtering information for subsequent service, on a reservation basis. In this case, the network skips the process of determining the CAC or the granted QoS. The network merely determines whether the MT is qualified to receive the corresponding service, simply through the QoS authentication process. With reference to FIG. 4, a description will now be made of a network-initiated new QoS setup method using the requested QoS and packet filtering information transmitted by the MT on a reservation basis.

An MT 100 sets up a main service with a PDSN 130 in step 401. The main service is created if an MT sets up a basic call to an AN. If the main service is successfully set up in step 401, the PDSN 130 transmits an Access Request message to an authentication server 150 in step 402. Then the authentication server 150 performs authentication by searching a QoS user profile for the MT 100. After successful authentication, the authentication server 150 transmits an Access Response message including the QoS user profile to PDSN 130 in step 403. The PDSN 130 transmits the QoS user profile to AN/PCF 110/120 in step 404. Then, in step 405, application program IP flow connection and QoS negotiation are achieved between the MT 100 and a CSCF or management server 160. Thereafter, in step 406, the MT 100 transmits a QoS New Reservation Request message including a desired service code #n, a required QoS and packet filtering information to AN/PCF 110/120 for receiving a network-initiated QoS setup for a particular service. In step 407, the AN/PCF 110/120 performs a basic QoS authentication process using the QoS user profile received in step 404. In step 406, in MT 100, a QoS manager 210 transmits the QoS in an air signaling format to AN/PCF 110/120 via L3 230, and RSVP handler 220 transmits the packet filtering information in a traffic format via IP layer 270 Thereafter, AN/PCF 110/120 transmits a QoS Registration Request message including the packet filtering information to PDSN 130 in step 408. Herein, the QoS Registration Request message is an RSVP message. Upon receiving the QoS Registration Request message, an RSVP handler 311 of PDSN 130 stores the packet filtering information received from MT 100 in a traffic filtering DB 312 in step 409. Upon success of the QoS setup, PDSN 130 transmits a QoS Registration Response message indicating the success of the QoS resource reservation to AN/PCF 110/120 in step 410. The registered QoS is a reserved QoS, and is used to determine whether to set up a new QoS later if a forwarded packet corresponding to the packet filtering information is received. The AN/PCF 110/120 stores therein the packet filtering information from the PDSN 130. Upon receiving the QoS Registration Response message indicating the success of the QoS resource reservation, AN/PCF 110/120 transmits a QoS New Reservation Response message indicating the success of the QoS resource reservation to MT 100 in step 411. Thereafter, if an initial packet is received from the CSCF or management server 160 in step 412, PDSN 130 transmits a New QoS Setup Request message for requesting a new QoS setup to AN/PCF 110/120 in step 413, if the reserved QoS is actually activated due to the initial packet. Then AN/PCF 110/120 determines a granted QoS to be applied to a wireless session and a network session through CAC using the QoS received from the MT 100 on a reservation basis in step 414, and transmits a New QoS Setup Request message for requesting new QoS setup to the MT 100 in step 415. If the new QoS setup is granted, the MT 100 transmits a New QoS Setup Response message to PDSN 130 via AN/PCF 110/120 in steps 416 and 417. If the new QoS setup is successfully performed in this manner, PDSN 130 starts transmitting packet data to MT 100 via AN/PCF 110/120 based on the newly set QoS and the packet filtering information in step 418.

In an alternative exemplary embodiment of the present invention, if MT 100 sends only the requested QoS to AN 110 in step 406 and receives information indicating a success of the new QoS reservation from AN 110 in step 411, MT 100 transmits an RSVP-like message including packet filtering information to PDSN 130.

If any one of the foregoing operations fails, PDSN 130 transmits packets to MT 100 using the QoS of the existing main service as is.

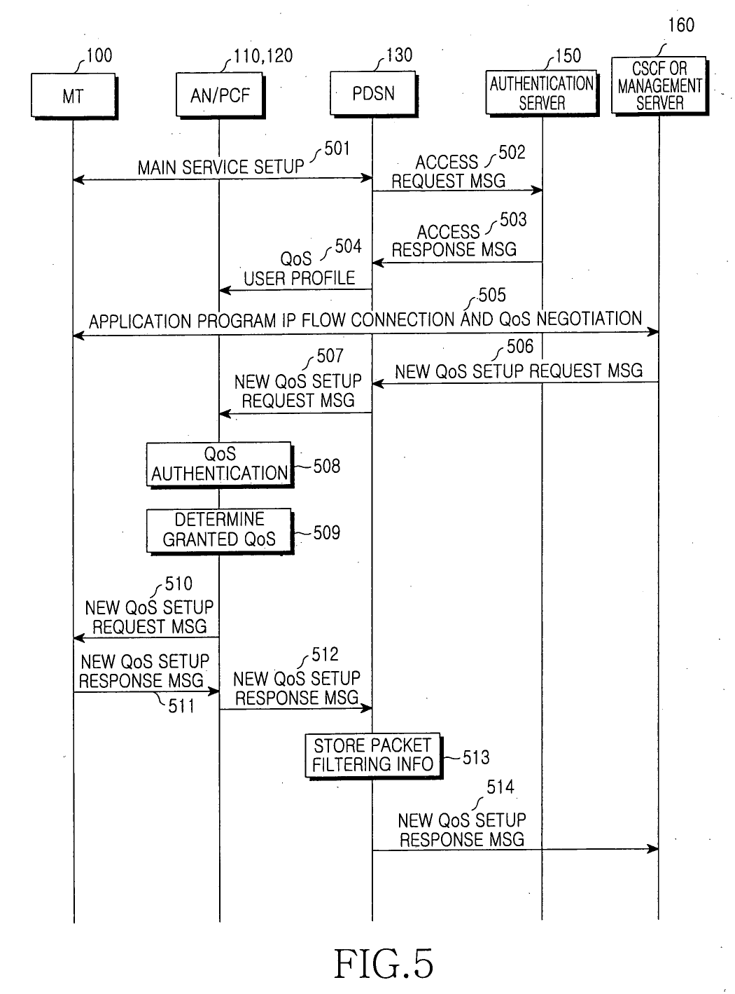

With reference to FIG. 5, a description will now be made of a QoS setup method in a mobile communication system according to another exemplary embodiment of the present invention.

In the scheme of FIG. 4, a network initiates a new QoS setup when the service desired by an MT is actually provided. However, FIG. 5 shows a pure network-initiated new QoS setup scheme.

An MT 100 sets up a main service with a PDSN 130 in step 501. The main service is created if the MT 100 sets up a basic call to an AN 110. If the main service is successfully set up in step 501, PDSN 130 transmits an Access Request message to an authentication server 150 in step 502. Then the authentication server 150 performs authentication by searching a QoS user profile for MT 100. After a successful authentication, the authentication server 150 transmits an Access Response message including the QoS user profile to PDSN 130 in step 503. PDSN 130 transmits the QoS user profile to AN/PCF 110/120 in step 504. Then, in step 505, application program IP flow connection and QoS negotiation are achieved between MT 100 and a CSCF or management server 160. After the QoS negotiation, PDSN 130 receives a New QoS Setup Request message including a service code #n, a requested QoS and packet filtering information from the CSCF or management server 160 in step 506. FIG. 5 is different from FIG. 4 in that PDSN 130 receives a new QoS setup request in a signaling message format from the CSCF or management server 160. In step 506, CSCF or management server 160 in a network, performing CSCF or actual QoS control, delivers the QoS and packet filtering information suitable for an application program to be serviced for the MT 100. The QoS suitable for the application program is determined such that a preferred QoS value previously registered by a user receiving a program service in the CSCF or management server 160 for the corresponding service is reflected in a basic service QoS. The preferred QoS value cannot be greater than the basic service QoS value, and basically, CSCF or management server 160 gives highest priority to the preferred QoS. Then PDSN 130 temporarily stores the packet filtering information and transmits a New QoS Setup Request message to the AN/PCF 110/120 in step 507. The AN/PCF 110/120 performs a QoS authentication process through CAC using the requested QoS in step 508. The AN/PCF 110/120 determines a granted QoS to be applied to a wireless session through a QoS authentication process and CAC using the requested QoS in step 509. If AN/PCF 110/120 determines to accept the new QoS setup, it transmits a New QoS Setup Request message for requesting a new QoS setup to MT 100 in step 510. The New QoS Setup Request message is transmitted to MT 100 along with the packet filtering information as well as the granted QoS. MT 100 searches for an application program that will appropriately process the corresponding service according to the received packet filtering information. MT 100 informs AN/PCF 110/120 whether to grant the new QoS setup requested by AN/PCF 110/120, in step 511. If MT 100 accepts the new QoS setup in step 511, AN/PCF 110/120 transmits a New QoS Setup Response message to PDSN 130 in step 512, to inform PDSN 130 of the acceptance of the new QoS setup. The New QoS Setup Response message includes the granted QoS. Upon receiving the New QoS Setup Response message, PDSN 130 normally stores, in step 513, the temporarily stored packet filtering information, and transmits all the next packets related to the corresponding packet filtering information using an IP QoS obtained by converting the granted QoS provided from AN 110. In step 514, PDSN 130 transmits a New QoS Setup Response message to the CSCF or management server 160 so that it may receive an appropriate service according to network and wireless-session QoS scheduling for the service corresponding to the QoS setup newly created by the CSCF or management server 160.

Exemplary embodiments of the present invention can efficiently use resources because it allocates wireless and network resources at the time when the traffic is actually available in a mobile communication system.

As can be understood from the foregoing description, exemplary embodiments of the present invention previously registers, in a network, QoS and packet filtering information for the service desired by an MT for a particular condition, and provides a service through network-initiated new QoS setup at the time when the service is actually provided. As a result, the exemplary embodiments of the present invention can be applied to network-based services such as a Push service.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method for setting up a quality-of-service (QoS) in a mobile communication system including a mobile terminal (MT), an access network (AN) for performing packet communication with the MT, a packet control function (PCF) for controlling an exchange of packet data between the AN and the MT, and a packet data service node (PDSN) for exchanging packet data with the PCF and for connecting with an external network, the method comprising the steps of:
generating, by the MT, a resource reservation message including requested QoS information and packet filtering information for a predetermined service;
storing, by the PDSN, the QoS information and the packet filtering information;
sending a request for a new QoS setup from the PDSN to the AN, upon receiving packet data corresponding to the stored QoS information from the external network;
determining, by the AN, a granted QoS to be applied to a wireless session;
sending, by the AN, a request for a new QoS setup to the MT; and
sending, if the MT grants the new QoS setup, a response to the new QoS setup request from the MT to the PDSN via the AN.

2. The method of claim 1, further comprising the step of receiving, by the MT, data including new QoS information from the PDSN and performing communication according to the new QoS information, if the MT grants the new QoS setup.

3. The method of claim 1, wherein the requested QoS information is transmitted in a signaling format and the packet filtering information is transmitted in a traffic format.

4. A method for setting up a quality-of-service (QoS) in a mobile communication system including a mobile terminal (MT), an access network (AN) for performing packet communication with the MT, a packet control function (PCF) for controlling an exchange of packet data between the AN and the MT, and a packet data service node (PDSN) for exchanging packet data with the PCF and for connecting with an external network, the method comprising the steps of:
receiving, by the PDSN, a new QoS setup request message including requested QoS information and packet filtering information from the external network;
delivering, by the PDSN, the received new QoS setup request message to the AN;
determining, by the AN, a granted QoS to be applied to a wireless session;
transmitting, by the AN, a new QoS setup request message to the MT;
transmitting, if the MT grants new QoS setup, a new QoS setup response message from the MT to the PDSN;
storing, by the PDSN, the QoS information and the packet filtering information; and
transmitting, by the PDSN, the new QoS setup response message to the external network.

5. The method of claim 4, further comprising the step of performing, by the AN, authentication using the requested QOS;

6. A method for setting up a quality-of-service (QoS) in a packet data service node (PDSN) for a mobile communication system including a mobile terminal (MT), an access network (AN) for performing packet communication with the MT, a packet control function (PCF) for controlling an exchange of packet data between the AN and the MT, and the PDSN for exchanging packet data with the PCF and for connecting with an external network, the method comprising the steps of:
receiving from the MT a resource reservation protocol (RSVP) message including requested QoS information and packet filtering information for a predetermined service;
storing the received QoS information and packet filtering information;
sending a request for new QoS setup to the AN, upon receiving packet data corresponding to the stored QoS information from the external network; and
receiving a response to the new QoS setup request via the AN if the AN determines a granted QoS to be applied to a wireless session and sends a request for a new QoS setup to the MT, and the MT grants the new QoS setup.

7. The method of claim 6, further comprising the step of transmitting data including the new QoS information to the MT, if the MT grants the new QoS setup.

8. The method of claim 6, wherein the requested QoS information is transmitted in a signaling format and the packet filtering information is transmitted in a traffic format.

9. A method for setting up a quality-of-service (QoS) in a packet data service node (PDSN) for a mobile communication system including a mobile terminal (MT), an access network (AN) for performing packet communication with the MT, a packet control function (PCF) for controlling an exchange of packet data between the AN and the MT, and the PDSN for exchanging packet data with the PCF and for connecting with an external network, the method comprising the steps of:
receiving a new QoS setup request message including requested QoS information and packet filtering information from the external network, and delivering the received new QoS setup request message to the AN;
receiving a new QoS setup response message from the MT;
storing the QoS information and the packet filtering information; and
transmitting the new QoS setup response message to the external network.

10. The method of claim 9, wherein receiving a new QoS setup response message from the MT, if the AN performs authentication in response to the QoS setup request, determines a granted QoS to be applied to a wireless session and transmits a new QoS setup request message to the MT, and the MT grants the new QoS setup.

11. A method for setting up a quality-of-service (QoS) in a mobile terminal (MT) for a mobile communication system including the MT, an access network (AN) for performing packet communication with the MT, a packet control function (PCF) for controlling an exchange of packet data between the AN and the MT, and a packet data service node (PDSN) for exchanging packet data with the PCF and for connecting with an external network, the method comprising the steps of:
generating a resource reservation protocol (RSVP) message including requested QoS information and packet filtering information for a predetermined service;
transmitting the generated RSVP message to the PDSN;
sending a request for a new QoS setup to the AN and receiving a new QoS setup request from the AN that determines a granted QoS to be applied to a wireless session, if the PDSN stores the QoS information and the packet filtering information and receives packet data corresponding to the stored QoS information from the external network; and
sending a response to the new QoS setup request to the PDSN via the AN if the MT grants the new QoS setup.

12. The method of claim 11, further comprising the step of receiving data including QoS information from the PDSN and performing communications according to the QoS information, if the MT grants the new QoS setup.

13. The method of claim 12, wherein the requested QoS information is transmitted in a signaling format and the packet filtering information is transmitted in a traffic format.

14. A method for setting up a quality-of-service (QoS) in a mobile communication system including a mobile terminal (MT), an access network (AN) for performing packet communication with the MT, a packet control function (PCF) for controlling an exchange of packet data between the AN and the MT, and a packet data service node (PDSN) for exchanging packet data with the PCF and for connecting with an external network, the method comprising the steps of:
delivering, by the PDSN, a new QoS setup request message including requested QoS information and packet filtering information received from the external network to the AN;
receiving, from the AN, a new QoS setup request message that performs authentication in response to the QoS setup request and determines a granted QoS to be applied to a wireless session;
transmitting, if the MT grants the new QoS setup, a new QoS setup response message from the MT to the PDSN; and
storing, by the PDSN, the QoS information and the packet filtering information; and
transmitting, by the PDSN, the new QoS setup response message to the external network.

15. An apparatus for setting up a quality-of-service (QoS) in a mobile terminal (MT) for a mobile communication system including the MT, an access network (AN) for performing packet communication with the MT, a packet control function (PCF) for controlling an exchange of packet data between the AN and the MT, and a packet data service node (PDSN) for exchanging packet data with the PCF and for connecting with an external network, the apparatus comprising:
a QoS manager for transmitting a QoS registration request message including a requested QoS in order to deliver QoS information requested by a client to the PDSN; and
a resource reservation protocol (RSVP) handler for delivering packet filtering information to the PDSN via an Internet protocol (IP) layer.

16. An apparatus for setting up a quality-of-service (QoS) in a packet data service node (PDSN) for a mobile communication system including a mobile terminal (MT), an access network (AN) for performing packet communication with the MT, a packet control function (PCF) for controlling an exchange of packet data between the AN and the MT, and the PDSN for exchanging packet data with the PCF and for connecting with an external network, the apparatus comprising:
a traffic filtering storage for storing packet filtering information and requested QoS information received from the MT;
a packet handler for classifying a packet received from the external network;
a session handler for performing a QoS setup if the packet received from the external network coincides with the packet filtering information stored in the traffic filtering storage; and
a signaling handler for transmitting the packet to the MT.
